(19) United States
(12) Patent Application Publication
(10) Pub. No.: US 2013/0266044 A1
(43) Pub. Date: Oct. 10, 2013

(54) COMMUNICATION SYSTEM AND TEST APPARATUS

(71) Applicant: ADVANTEST CORPORATION, Tokyo (JP)

(72) Inventor: Kazumoto TAMURA, Gunma (JP)

(21) Appl. No.: 13/865,213

(22) Filed: Apr. 18, 2013

Related U.S. Application Data
(63) Continuation of application No. PCT/JP2011/002010, filed on Apr. 4, 2011.

(51) Int. Cl. H04L 7/00

(52) U.S. Cl. CPC H04L 7/00
USPC 375/211

(57) ABSTRACT

To lower the cost of an apparatus. A test apparatus including a first communication device and a second communication device is provided. The first communication device includes a first transmitting unit that transmits, to the second communication device, a signal including a control code of a code value corresponding to a transmission rate to be used in communication between the first communication device and the second communication device when the communication is not established therebetween, and the second communication device includes: a first receiving unit that receives a signal from the first communication device; and a specifying unit that specifies the transmission rate corresponding to the control code included in the signal transmitted from the first communication device when the communication is not established between the first communication device and the second communication device.

### BACKGROUND

1. Technical Field

The present invention relates to a communication system and a test apparatus.

2. Related Art

When a constant bit rate first communication device and a variable bit rate second communication device transmit and receive serial signals, the second communication device changes its bit rate to match with the bit rate of the first communication device. In one example, at the time of linkup process, the second communication device regenerates a clock of a serial signal transmitted from the first communication device, and sets the bit rate by measuring the frequency of the regenerated clock by using a counter.

However, when the bit rate of a transmitted or received serial signal is high, the second communication device has to be provided with a counter that operates at a high rate. Accordingly, such a system in which one communication device adapts its bit rate to the bit rate of another communication device incurs a large cost of a circuit for use in linkup process.

### SUMMARY

Then, one aspect of the innovation included in the present specification provides a communication system and a test apparatus that can solve the above-described problems. This object is achieved by a combination of features described in claims. That is, a first aspect of the present invention provides a communication system and a test apparatus. The communication system is provided with a first communication device and a second communication device. The first communication device includes a first transmitting unit that transmits, to the second communication device, a signal including a control code of a code value corresponding to a transmission rate to be used in communication between the first communication device and the second communication device when the communication is not established therebetween. The second communication device includes: a first receiving unit that receives a signal from the first communication device; and a specifying unit that specifies the transmission rate corresponding to the control code included in the signal transmitted from the first communication device when the communication is not established between the first communication device and the second communication device.

A second aspect of the present invention provides a communication system and a test apparatus. The communication system is provided with a first communication device and a second communication device. The first communication device includes a first transmitting unit that transmits, to the second communication device, a signal including a control code of a code value corresponding to a transmission protocol to be used in communication between the first communication device and the second communication device when the communication is not established therebetween. The second communication device includes: a first receiving unit that receives a signal from the first communication device; and a specifying unit that specifies the transmission protocol corresponding to the control code included in the signal transmitted from the first communication device when the communication is not established between the first communication device and the second communication device.

A third aspect of the present invention provides a communication system and a test apparatus. The communication system is provided with a first communication device and a second communication device. The first communication device includes a first transmitting unit that transmits, to the second communication device, a signal including a control code of a code value corresponding to a transmission rate and a transmission protocol to be used in communication between the first communication device and the second communication device when the communication is not established therebetween. The second communication device includes: a first receiving unit that receives a signal from the first communication device; and a specifying unit that specifies the transmission rate and the transmission protocol corresponding to the control code included in the signal transmitted from the first communication device when the communication is not established between the first communication device and the second communication device.

The summary clause does not necessarily describe all necessary features of the embodiments of the present invention. The present invention may also be a sub-combination of the features described above.

### BRIEF DESCRIPTION OF THE DRAWINGS

FIG. 1 shows a configuration of a test apparatus 10 according to the present embodiment.

FIG. 2 shows a configuration of each of a plurality of test units 12, and a configuration of a relay device 16.

FIG. 3 shows a configuration of a first communication device 22 and a configuration of a second communication device 24.

FIG. 4 shows a process flow for establishing communication between the first communication device 22 and the second communication device 24.

FIG. 5 shows a configuration of a specifying unit 44 provided to the second communication device 24.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

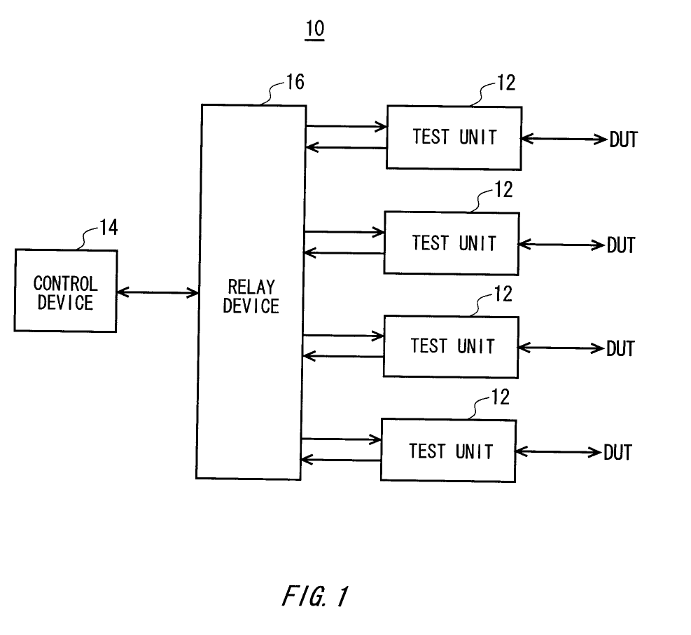

FIG. 1 shows a configuration of a test apparatus 10 according to the present embodiment. The test apparatus 10 tests a device under test (DUT) such as a semiconductor device. The test apparatus 10 includes one or a plurality of a test unit(s) 12, a control device 14, and a relay device 16.

Each test unit 12 exchanges signals with a device under test. In one example, the test unit 12 supplies, to a device under test, a test signal having a waveform according to a test pattern, compares a response signal from the device under test with a logical value according to an expected value pattern, and thereby determines whether the device under test passes or fails the test.

The control device 14 provides a command to each of the one or plurality of the test unit(s) 12, and controls each test unit 12. In one example, the control device 14 is realized by a computer that serves as the control device 14 by executing a program.

The relay device 16 relays a command transmitted to the one or plurality of the test unit(s) 12, and a response transmitted to the control device 14. The control device 14 and the relay device 16 are connected by Ethernet® and the like. The relay device 16 and each test unit 12 transmit and receive serial signals to and from one another.

In the present embodiment, a serial signal transmitted between the relay device 16 and each test unit 12 is a signal complying with a high-speed serial transfer standard called 8b/10b (or 10b/8b). The serial signal may be a signal complying with other standards such as USB 3.0 and PCI Express. Also, the control device 14 and the relay device 16 may transmit and receive similar serial signals to and from one another.

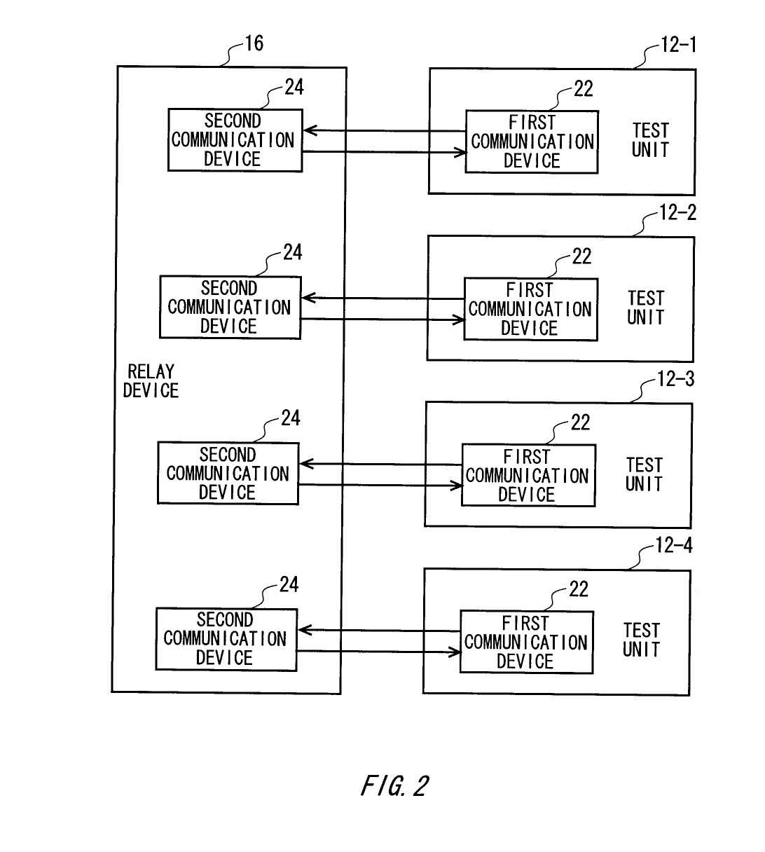

FIG. 2 shows a configuration of each of the plurality of the test units 12, and a configuration of the relay device 16. Each test unit 12 has a first communication device 22 that performs serial communication with the relay device 16. Also, the relay device 16 has, corresponding to each of the one or plurality of the test unit(s) 12, a second communication device 24 that performs serial communication with the corresponding test unit 12.

A transmission rate of a serial signal transmitted and received by the first communication device 22 provided to each test unit 12 is fixed. That is, the first communication device 22 provided to each test unit 12 transmits and receives, to and from the corresponding second communication device 24 provided to the relay device 16, a serial signal at a transmission rate that is predetermined for the first communication device 22.

Also, a transmission rate of a signal transmitted and received by the first communication device 22 provided to each of the plurality of the test unit(s) 12 may be different from another first communication device 22. For example, a transmission rate of a serial signal transmitted and received by the first communication device 22 of a first test unit 12-1 may be fixed at 10 G bits/second, and a transmission rate of a serial signal transmitted and received by the first communication devices 22 of other test units 12-1 to 12-4 may be fixed at 100 G bits/second.

A transmission rate of a signal transmitted and received by each second communication device 24 provided to the relay device 16 is variable. Each second communication device 24 provided to the relay device 16 adapts a transmission rate of a serial signal transmitted and received by itself to a transmission rate of a serial signal transmitted and received by the first communication device 22 provided to the corresponding test unit 12 to be a communication target.

Here, in the 8b/10b standard, a serial signal in which a clock is embedded in a data column is transmitted and received. Also, in the 8b/10b standard, a signal is transmitted and received by converting 8-bit data into 10-bit data. In the 8b/10b standard, conversion from 8-bit data into 10-bit data, and inverse conversion thereof are performed by referring to a table. In the 8b/10b standard, a 10-bit code for transmitting information to a communication partner at the time of normal data transmission and reception is called a D code.

Also, in the 8b/10b standard, linkup process is performed to establish communication before transmitting and receiving data. In the linkup process, a serial signal including a specific control code is transmitted from a transmitter side, and on a receiver side, clock regeneration process for regenerating a clock from the serial signal including the control code, and word alignment process for detecting a word clipping position are performed. Also, the control code transmitted in the linkup process is called a K code in the 8b/10b standard.

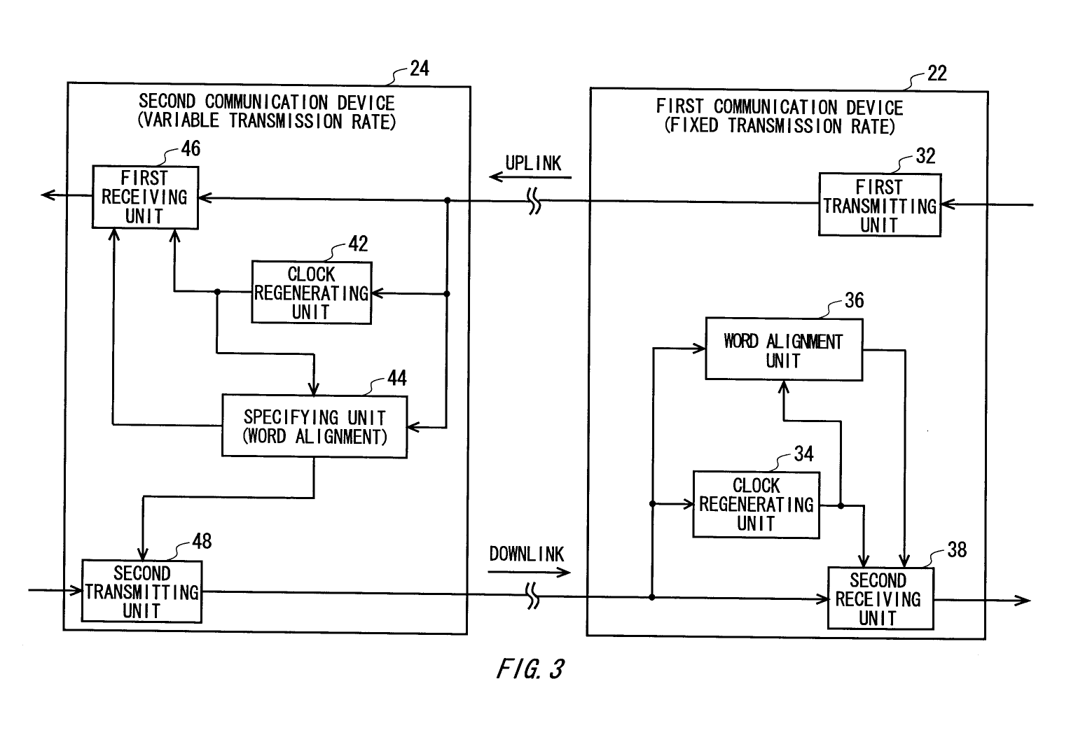

FIG. 3 shows a configuration of the first communication device 22 and a configuration of the second communication device 24. The first communication device 22 includes a first transmitting unit 32, a clock regenerating unit 34, a word alignment unit 36 and a second receiving unit 38.

The first transmitting unit 32 receives data from a circuit in the test unit 12, converts the received data into a serial signal complying with the 8b/10b standard, and transmits the serial signal to the second communication device 24 via an uplink. The first transmitting unit 32 transmits a serial signal at a predetermined, fixed transmission rate.

The clock regenerating unit 34 receives the serial signal transmitted from the second communication device 24 via a downlink, and regenerates a clock of the serial signal. The word alignment unit 36 outputs, based on the clock regenerated by the clock regenerating unit 34, a clipping signal indicating a word clipping position in the serial signal transmitted from the second communication device 24.

The second receiving unit 38 receives the serial signal that is transmitted from the second communication device 24 and complying with the 8b/10b standard via a downlink. Then, the second receiving unit 38 converts the received serial signal into data in a format that can be processed by a circuit in the test unit 12. In this case, the second receiving unit 38 receives the serial signal based on the clock regenerated by the clock regenerating unit 34, and also clips data in units of words from a bit string included in the serial signal at a position indicated by the clipping signal output by the word alignment unit 36.

The second communication device 24 is provided with a clock regenerating unit 42, a specifying unit 44, a first receiving unit 46 and a second transmitting unit 48. The clock regenerating unit 42 receives a serial signal transmitted from the first communication device 22 via an uplink, and regenerates a clock of the serial signal. The specifying unit 44 outputs, based on the clock regenerated by the clock regenerating unit 42, a clipping signal indicating a word clipping position in the serial signal transmitted from the first communication device 22.

The first receiving unit 46 receives the serial signal that is transmitted from the first communication device 22 and complying with the 8b/10b standard via an uplink. Then, the first receiving unit 46 converts the received serial signal into data in a format that can be processed by a circuit used in a latter step. In this case, the first receiving unit 46 receives the serial signal based on the clock regenerated by the clock regenerating unit 42, and also clips data in units of words from a bit string included in a serial signal at a position indicated by the clipping signal output by the specifying unit 44.

The second transmitting unit 48 receives data from a circuit in the control device 14, converts the received data into a serial signal complying with the 8b/10b standard, and transmits the serial signal to the second communication device 24 via a downlink. The second transmitting unit 48 changes, in accordance with the transmission rate of the serial signal transmitted from the first transmitting unit 32 of the first communication device 22, the transmission rate of the serial signal to be transmitted.

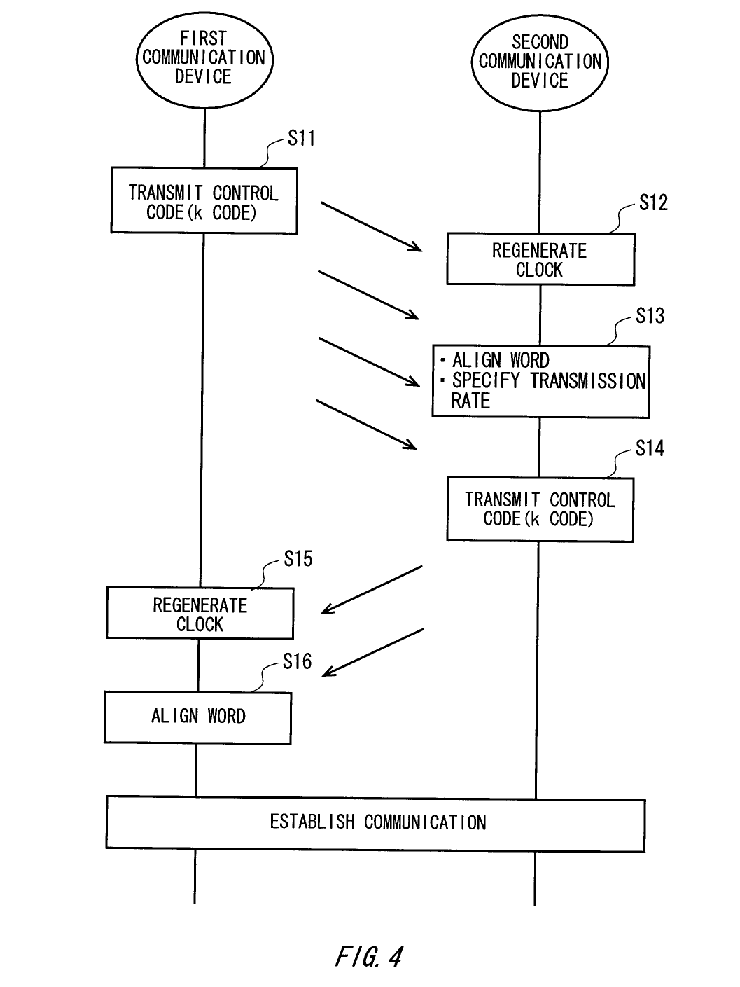

FIG. 4 shows a process flow for establishing communication between the first communication device 22 and the second communication device 24. The first communication device 22 and the second communication device 24 execute linkup process for establishing communication between the first communication device 22 and the second communication device 24 when the communication is not established therebetween.

In the linkup process, the first communication device 22 and the second communication device 24 execute clock regeneration process and word alignment process on both an uplink for conveying signals from the first communication device 22 to the second communication device 24 and a downlink for conveying signals from the second communication device 24 to the first communication device 22. Specifically, the first communication device 22 and the second communication device 24 execute linkup process by the procedure shown in FIG. 4.

In the linkup process, first, the first transmitting unit 32 of the first communication device 22 transmits a serial signal including a control code (for example, a K code) to the second communication device 24 (S11). Here, a code value of the control code is predetermined according to a transmission rate of a serial signal, and is specific to each transmission rate. Accordingly, at the step S11, the first transmitting unit 32 of the first communication device 22 transmits, to the second communication device 24, a serial signal including a control code of a code value according to a fixed transmission rate used by the first communication device 22 for communication. In this case, the first transmitting unit 32 of the first communication device 22 transmits repeatedly and continuously, to the second communication device 24, serial codes including control codes.

Subsequently, the clock regenerating unit 42 of the second communication device 24 regenerates a clock from a serial signal transmitted from the first communication device 22 (S12). Subsequently, the specifying unit 44 of the second communication device 24 performs word alignment process on the serial signal transmitted from the first communication device 22 (S13).

Furthermore, at the step S13, the specifying unit 44 of the second communication device 24 detects to which one of a plurality of transmission rates a code value of a control code included in the serial signal transmitted from the first communication device 22 corresponds, and specifies the transmission rate according to the control code included in the serial signal. In one example, the specifying unit 44 of the second communication device 24 switches and specifies a control code of each of the plurality of transmission rates at every predetermined interval, aligns a serial signal with a specified control code, and determines that the specified control code is included in the serial signal under a condition that the alignment is performed successfully.

Subsequently, the specifying unit 44 of the second communication device 24 provides the specified transmission rate to the second transmitting unit 48. The second transmitting unit 48 of the second communication device 24 transmits, to the second communication device 24, the serial signal at the transmission rate specified by the specifying unit 44 (S14). In this case, the second transmitting unit 48 of the second communication device 24 transmits, to the second communication device 24, the serial signal including a control code (for example, a K code) of the code value according to the specified transmission rate.

Subsequently, the clock regenerating unit 34 of the first communication device 22 regenerates a clock from the serial signal transmitted from the second communication device 24 (S15). Subsequently, the clock regenerating unit 34 of the first communication device 22 performs word alignment process on the serial signal transmitted from the second communication device 24 (S16).

Upon completion of the process from the step S11 to the step S16, clock regeneration process and word alignment process on both the uplink and the downlink complete. Thereby, the uplink and the downlink are established for the first communication device 22 and the second communication device 24, and the first communication device 22 and the second communication device 24 can thereafter perform normal serial communication.

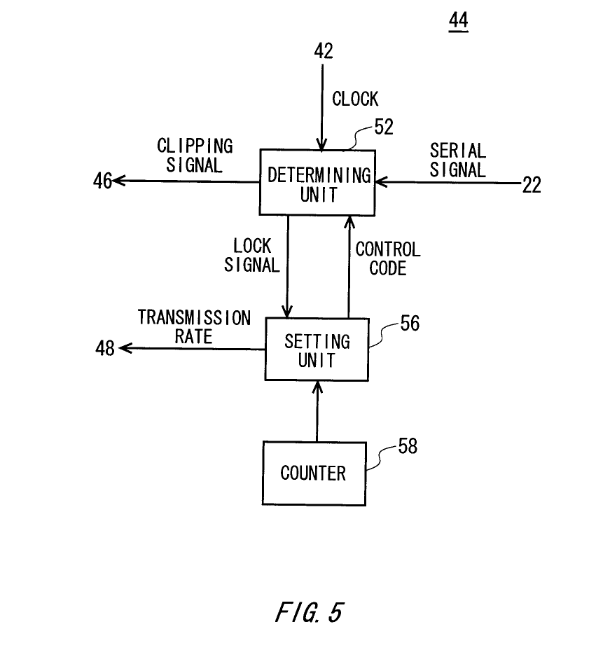

FIG. 5 shows a configuration of the specifying unit 44 provided to the second communication device 24. The specifying unit 44 has a determining unit 52, a setting unit 56 and a counter 58.

When communication is not established between the first communication device 22 and the second communication device 24, the determining unit 52 receives a serial signal transmitted from the first communication device 22, and executes word alignment process. In the word alignment process, the determining unit 52 is notified of a code value of a control code specified by the setting unit 56.

Then, the determining unit 52 aligns the serial signal transmitted from the first communication device 22 with the code value of the specified control code. That is, the determining unit 52 determines whether the code value of the specified control code is included in a bit string of the serial signal transmitted from the first communication device 22.

When the alignment is performed successfully, that is, the code value of the control code is determined to be included, the determining unit 52 decides a word clipping position based on the position of the detected control code. After deciding the word clipping position, the determining unit 52 outputs a lock signal. Thereafter, the determining unit 52 counts clock pulses, and generates a clipping signal at every timing of the decided word clipping position.

When communication is not established between the first communication device 22 and the second communication device 24, the setting unit 56 sequentially performs setting of the determining unit 52 to detect each of a plurality of control codes corresponding to a plurality of transmission rates.

In one example, the setting unit 56 selects sequentially a single code value of a control code corresponding to each of the plurality of the transmission rates at every predetermined interval. Then, the setting unit 56 specifies the control value of the selected control code for the determining unit 52. Thereby, the setting unit 56 can switch a control code to be detected by the determining unit 52 at every predetermined cycle.

Upon detection of a control code set for the determining unit 52, the setting unit 56 specifies a transmission rate of the serial signal transmitted from the first communication device 22 as a transmission rate corresponding to the control code. Then, the setting unit 56 supplies, to the second transmitting unit 48, information indicating the transmission rate specified for the second transmitting unit 48. Thereby, the second transmitting unit 48 can transmit, to the first communication device 22, a serial signal at a transmission rate that is identical with that of a serial signal transmitted from the first communication device 22.

The counter 58 generates a cycle at which the setting unit 56 switches a control code set for the determining unit 52. Thereby, the setting unit 56 can switch a control code at every predetermined interval.

The test apparatus 10 provided with the above-described first communication device 22 and second communication device 24 enables the second communication device 24 with a simple configuration to detect a transmission rate of a serial signal transmitted from the first communication device 22. Thereby, the cost of the second communication device 24, in the test apparatus 10, that can change a transmission rate can be lowered.

Note that the test apparatus 10 according to the present embodiment may have a configuration in which the first communication devices 22 provided to a plurality of the test units 12 transmit and receive serial signals complying with mutually different specific protocols. In such a case, a plurality of the second communication devices 24 provided to the relay device 16 may be able to change protocols corresponding to the test units 12. In this case, the first communication device 22 and the second communication device 24 in the test apparatus 10 transmit control codes that are predetermined according to the protocols and different for each protocol. Thereby, the test apparatus 10 enables the second communication device 24 with a simple configuration to detect a protocol of a serial signal transmitted from the first communication device 22.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A test apparatus that tests a device under test, the test apparatus comprising:
a test unit that tests the device under test by exchanging a signal with the device under test;
a control device that controls the test unit; and
a relay device that relays communication between the test unit and the control device; wherein
the test unit has a first communication device,
the control device has a second communication device corresponding to the test unit,
the first communication device includes a first transmitting unit that transmits, to the second communication device, a signal including a control code of a code value corresponding to a transmission rate to be used in communication between the first communication device and the second communication device when the communication is not established therebetween, and
the second communication device includes:
a first receiving unit that receives a signal from the first communication device; and
a specifying unit that specifies the transmission rate corresponding to the control code included in the signal transmitted from the first communication device when the communication is not established between the first communication device and the second communication device.

2. The test apparatus according to claim 1, wherein
the second communication device includes a clock regenerating unit that regenerates a clock from the signal transmitted from the first communication device, and
the first receiving unit receives the signal from the first transmitting unit based on the clock.

3. The test apparatus according to claim 1, wherein
the specifying unit includes:
a determining unit that determines whether the signal transmitted from the first communication device includes a specified control code; and
a setting unit that sequentially performs setting of the determining unit to detect each of a plurality of control codes corresponding to a plurality of the transmission rate, and
the setting unit specifies the transmission rate corresponding to a control code upon detection of the control code that is set for the determining unit.

4. The test apparatus according to claim 3, wherein the determining unit aligns the signal transmitted from the first communication device with the specified control code, and determines that the specified control code is included in the signal that is received, under a condition that alignment is performed successfully.

5. The test apparatus according to claim 3, wherein, at every predetermined interval, the setting unit switches a control code to be detected by the determining unit.

6. The test apparatus according to claim 1, wherein the second communication device further includes a second transmitting unit that transmits a signal to the first communication device at the transmission rate specified by the specifying unit.

7. The test apparatus according to claim 1, wherein
a transmission rate of a signal to be transmitted and received by the first communication device is fixed, and
a transmission rate of a signal to be transmitted and received by the second communication device is variable.

8. A test apparatus that tests a device under test, the test apparatus comprising:
a test unit that tests the device under test by exchanging a signal with the device under test;
a control device that controls the test unit; and
a relay device that relays communication between the test unit and the control device; wherein
the test unit has a first communication device,
the control device has a second communication device corresponding to the test unit,
the first communication device includes a first transmitting unit that transmits, to the second communication device, a signal including a control code of a code value corresponding to a transmission protocol to be used in communication between the first communication device and the second communication device when the communication is not established therebetween, and
the second communication device includes:
a first receiving unit that receives a signal from the first communication device; and
a specifying unit that specifies the transmission protocol corresponding to the control code included in the signal transmitted from the first communication device when the communication is not established between the first communication device and the second communication device.

9. The test apparatus according to claim 8, wherein
the second communication device includes a clock regenerating unit that regenerates a clock from the signal transmitted from the first communication device, and
the first receiving unit receives the signal from the first transmitting unit based on the clock.

10. The test apparatus according to claim 8, wherein the specifying unit includes:
a determining unit that determines whether the signal transmitted from the first communication device includes a specified control code; and
a setting unit that sequentially performs setting of the determining unit to detect each of a plurality of control codes corresponding to a plurality of the transmission protocol, and
the setting unit specifies the transmission protocol corresponding to a control code upon detection of the control code that is set for the determining unit.

11. The test apparatus according to claim 10, wherein the determining unit aligns the signal transmitted from the first communication device with the specified control code, and determines that the specified control code is included in the signal that is received, under a condition that alignment is performed successfully.

12. The test apparatus according to claim 10, wherein, at every predetermined interval, the setting unit switches a control code to be detected by the determining unit.

13. The test apparatus according to claim 8, wherein the second communication device further includes a second transmitting unit that transmits a signal to the first communication device with the transmission protocol specified by the specifying unit.

14. The test apparatus according to claim 8, wherein
a transmission protocol of a signal to be transmitted and received by the first communication device is fixed, and
a transmission protocol of a signal to be transmitted and received by the second communication device is variable.

15. A test apparatus that tests a device under test, the test apparatus comprising:
a test unit that tests the device under test by exchanging a signal with the device under test;
a control device that controls the test unit; and
a relay device that relays communication between the test unit and the control device; wherein
the test unit has a first communication device,
the control device has a second communication device corresponding to the test unit,
the first communication device includes a first transmitting unit that transmits, to the second communication device, a signal including a control code of a code value corresponding to a transmission rate and a transmission protocol to be used in communication between the first communication device and the second communication device when the communication is not established therebetween, and
the second communication device includes:
a first receiving unit that receives a signal from the first communication device; and
a specifying unit that specifies the transmission rate and the transmission protocol corresponding to the control code included in the signal transmitted from the first communication device when the communication is not established between the first communication device and the second communication device.
